(19) United States
(12) Patent Application Publication
(10) Pub. No.: US 2008/0248323 A1
(43) Pub. Date: Oct. 9, 2008

(54) Leather Care Using Lipophilic Fluids

(76) Inventors: Anna Vadimovna Radomyselski, Hamilton, OH (US); Keith Homer Baker, West Chester Twp, OH (US); Donna Jean Haeggberg, Cincinnati, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/138,930

(22) Filed: Jun. 13, 2008

Related U.S. Application Data
(63) Continuation of application No. 10/228,244, filed on Aug. 26, 2002.
(60) Provisional application No. 60/318,382, filed on Sep. 10, 2001.

(51) Int. Cl. C14C 9/00

(52) U.S. Cl. 428/540; 8/94.1 P; 8/94.1 R

(57) ABSTRACT

The present invention relates to processes and systems for treating leather articles, especially lipophilic fluid systems for treating leather articles. More particularly, the present invention relates to processes and systems employing treating agents that treat, for example clean, leather articles without causing damage to the appearance of the leather articles as compared to the leather articles' original appearance prior to treatment.

### CROSS REFERENCE TO RELATED APPLICATIONS

This application is a Continuation of U.S. application Ser. No. 10/228,244, filed Aug. 26, 2002, which claims priority to U.S. Provisional Application No. 60/318,382, filed Sep. 10, 2001.

### FIELD OF THE INVENTION

The present invention relates to processes and systems for treating leather articles, especially lipophilic fluid systems for treating leather articles. More particularly, the present invention relates to commercial dry cleaning processes and systems that employ treating agents that treat, for example clean, leather articles without causing damage to the appearance of the leather articles as compared to the leather articles' original appearance prior to treatment.

### BACKGROUND OF THE INVENTION

The cleaning of leather articles, especially finished leather articles such as leather garments, has been conventionally accomplished by a variety of means. Such means include various forms of wipes, brushes, and other topically applied compositions and/or systems oftentimes in conjunction with chemical additives used to enhance the performance of the compositions and/or systems.

Additionally, immersive cleaning is done on leather articles. The immersive cleaning of leather garments typically gives better cleaning results than the topical treatments. However, the practice of immersive cleaning of leather garments suffers from the solvent induced damage to the leather. The most typical solvents used to clean leather are water and perchloroethylene (PERC). In addition to water and PERC, other dry cleaning solvents or systems may be used such as the hydrocarbon-based and/or petroleum-based systems and/or CO2 based systems.

However, all of the conventional methods for cleaning and/or treating leather articles suffer from particular defects that reduce their desirability to treat/clean leather. Both water and PERC are known to strip fat liquors and dyes from the leather resulting in unacceptable stiffness and/or color change. The problems of using either water or PERC are well known in the art. As a result, much effort has been devoted to the development of leather treatment systems used in the production of leather that produces water washable and/or dry cleanable leather. See for example U.S. Pat. No. 5,501,707.

The hydrocarbon-based and/or petroleum-based solvent systems have an undesirable odor that is often difficult to remove.

The use of CO2 presents significant engineering difficulty due to the high pressure required to operate it effectively.

Therefore it is highly desirable that an improved immersive cleaning process for treating and/or cleaning leather articles, especially finished leather articles such as leather garments, be devised.

The use of lipophilic fluid (such as D5) as an immersive cleaning solvent for leather has been alluded to in the patent literature but not described in sufficient detail so as to allow the user to use it to clean leather in a satisfactory manner.

### SUMMARY OF THE INVENTION

The present invention fulfills the long-felt need described above by providing processes and/or systems, especially immersive processes and/or systems (non-immersive processes are also encompassed by the present invention even though immersive is referred to throughout this application), for treating, such as cleaning, leather articles, especially finished leather articles such as leather garments, that do not have the associated problems described above for conventional leather treating and/or cleaning processes.

In one aspect of the present invention, a process for treating a leather article comprising the step of contacting the leather article with a treating composition comprising a lipophilic fluid and a treating agent wherein the treating agent is insoluble in water, such that the appearance of the leather article is not damaged as compared to its original appearance prior to contacting with the treating composition, is provided.

In another aspect of the present invention, a process for treating a leather article comprising the step of contacting the leather article with a treating composition comprising a lipophilic fluid and a treating agent wherein the treating agent is insoluble in water and contacting the leather article with a replenishing composition before, during, and/or after contacting with the treating composition such that the appearance of the leather article is not damaged as compared to its original appearance prior to contacting with the treating composition, is provided.

In another aspect of the present invention, a leather article treated by a process according to the present invention is provided.

In yet another aspect of the present invention, a process for treating a soiled leather article comprising contacting the soiled leather article with a treating composition comprising an effective amount, preferably from about 0.001% to about 5%, more preferably from about 0.001% to about 3%, even more preferably from about 0.01% to about 1% by weight of the treating composition, of a treating agent such that the soil is removed and/or reduced from the leather article without damage to the appearance of the leather article as compared to its original appearance prior to contacting it with the treating composition is provided.

In still another aspect of the present invention, a leather article treating composition (in-use) comprising by weight:

a. from about 0.001% to about 5% of a treating agent;

b. from about 0% to about 5% of water;

c. from about 80% to about 99.999% of a lipophilic fluid;

d. optionally, from about 0% to about 5% of a leather adjunct is provided.

A process for treating a leather article comprising the step of contacting the leather article with a treating composition comprising:

a. from about 0.001% to about 5% by weight of the treating composition of a treating agent; and

b. optionally, water; and

c. optionally, a leather adjunct; and

d. balance, a lipophilic fluid, is provided.

A process wherein the treating composition comprises the treating agent and water in a combined level of from about 0.001% to about 5% by weight of the treating composition, is provided.

In even yet another aspect of the present invention, a leather article treating process wherein the leather article is treated in an apparatus that has been used previously to treat non-leather fabric articles by contacting the non-leather fabric articles with a non-leather fabric article treating agents that are capable of damaging the leather article, the process comprising the steps of:

a. removing from and/or reducing the level present in the apparatus of the non-leather fabric article treating agents that are capable of damaging the leather article;

b. placing the leather article into the apparatus;

c. contacting the leather article with a treating composition comprising a lipophilic fluid and a treating agent wherein the treating agent is insoluble in water such that the appearance of the leather article is not damaged as compared to its original appearance prior to contacting with the treating composition; and

d. optionally, contacting the treated leather article from Step (c) with a replenishing composition; and

e. optionally, drying the leather article; and

f. optionally, removing the leather article from the apparatus is provided.

In still another aspect of the present invention, a consumable leather article treating composition (neat product) comprising by weight:

a. from about 1% to about 100% of a treating agent;

b. from about 0% to about 99% of water;

c. from about 0% to about 99% of a lipophilic fluid;

d. optionally, from about 0% to about 99% of a leather adjunct is provided.

The object of the invention is to provide an improved method for the immersive cleaning of leather wherein the leather itself is not importantly degraded by or damaged by the cleaning process. This is accomplished by the immersive washing of the leather in a solvent system comprising D5 and/or other siloxane solvents. While the cleaning system comprises D5 and/or other siloxane solvents, the level and type of other cleaning ingredients are critical to achieving the objective of this invention. It is a further object of this invention to achieve the performance objectives (e.g., cleaning and garment safety) in an efficient and uncomplicated manner such that it can easily and economically used.

The first aspect of the invention provides a preferred method for cleaning leather and suede in D5 and/or other siloxanes wherein the loss of dyes from the leather and the transfer of the dyes to other surfaces is greatly diminished. It was discovered that low levels of water and certain surfactants could lead to the highly undesirable loss of dyes from leather and their subsequent redeposition on other garment surfaces in the wash. Importantly, the cleaning of sebaceous soils is not significantly affected by the absence or either water or surfactant.

The present invention provides processes for cleaning and/or treating leather articles that avoids damage to the leather articles and compositions for use in such processes.

### DETAILED DESCRIPTION

### Definitions

The term “leather article” herein means any article that comprises wholly or partially, a material which is composed of an animal hide or skin that is tanned or treated such that the material is imputrescible. Examples of leather articles are grain leather articles and/or suede leather articles.

The term “finished leather article” herein means a leather article which has been processed (i.e., finished) in a way that adds value to a consumer (i.e., a purchaser of the finished leather article). Nonlimiting examples of finished leather articles include, leather garments (i.e., skirts, coats, pants), leather accessories (i.e., belts, gloves, bags, purses, shoes), and leather furniture/upholstery (i.e., leather chairs, leather sofas, linen, drapery, furniture covers), tarpaulins and the like. Such finished leather articles are customarily cleaned in a conventional laundry process and/or in a dry cleaning process.

The term “deleterious effect” and/or “damage” to the leather article herein means that the physical and/or aesthetic properties of the finished leather article have been negatively impacted. Such deleterious effects may occur in the structure and/or integrity of the finished leather article and/or on the finished surface of the finished leather article. Nonlimiting examples of deleterious effects on finished leather articles include shrinkage, cracking, discoloring, loss of suppleness and/or loss of feel. Once a deleterious effect has occurred to a finished leather article, the finished leather article typically loses value to the owner of the finished leather article because the owner may cease or reduce the use of the finished leather article.

The term “lipophilic fluid” used herein is intended to mean any nonaqueous fluid capable of removing sebum, as described in more detail herein below.

The specific term “D5” unless otherwise specified herein is intended to mean any lipophilic fluid as described herein.

The terms “leather article cleaning composition” and/or “leather article treating composition” used herein are intended to mean any composition, especially a lipophilic fluid-containing composition, which comes into direct contact with leather articles to be cleaned and/or treated. It should be understood that the term encompasses uses other than cleaning, such as conditioning and sizing. Furthermore, optional cleaning adjuncts such as additional surfactants other than those surfactants described above, bleaches, and the like may be added to the “treating composition”. That is, cleaning adjuncts may be optionally combined with the lipophilic fluid. These optional cleaning adjuncts are described in more detail herein below. Such cleaning adjuncts may be present in the treating compositions of the present invention at a level of from 0.01% to about 10% by weight of the treating composition.

The term “soil” means any undesirable substance on a leather article that is desired to be removed. By the terms “water-based” or “hydrophilic” soils, it is meant that the soil comprised water at the time it first came in contact with the leather article, or the soil retains a significant portion of water on the leather article. Examples of water-based soils include, but are not limited to beverages, many food soils, water soluble dyes, bodily fluids such as sweat, urine or blood, outdoor soils such as grass stains and mud.

The term “capable of suspending water in a lipophilic fluid” means that a material is able to suspend, solvate or emulsify water, which is immiscible with the lipophilic fluid, in a way that the water remains visibly suspended, solvated or emulsified when left undisturbed for a period of at least five minutes after initial mixing of the components. In some examples of compositions in accordance with the present invention, the compositions may be colloidal in nature and/or appear milky. In other examples of compositions in accordance with the present invention, the compositions may be transparent.

The term “insoluble” means that when added to a fluid material, an agent physically separates from the material (i.e., settle-out, flocculate, float) within 5 minutes after addition to the material and/or the resulting mixture is visibly cloudy after at least 5 minutes after addition to the material.

The term “lipophilic fluid soluble” means that when added to a lipophilic fluid, a material does not physically separate from the lipophilic fluid (i.e. settle-out, flocculate, float) within 5 minutes after addition to the lipophilic fluid and/or the resulting mixture is visibly clear after at least 5 minutes after addition to the lipophilic fluid.

The term “solubilizing aid and/or agent” means an agent that increases the solubility of a material within a fluid. A nonlimiting example of a solubilizing agent comprises alcohols, especially isopropyl alcohol.

The term “consumable leather article treating composition” means any composition, that when combined with a separate, discrete lipophilic fluid, results in a leather article treating composition according to the present invention.

The term “processing aid” refers to any material that renders the consumable leather treating composition more suitable for formulation, stability, and/or dilution with a lipophilic fluid to form a treating composition in accordance with the present invention.

The term “mixing” as used herein means combining two or more materials (i.e., fluids, more specifically a lipophilic fluid and a consumable detergent composition) in such a way that a homogeneous mixture is formed. Suitable mixing processes are known in the art. Nonlimiting examples of suitable mixing processes include vortex mixing processes and static mixing processes.

### Leather Article Treating/Cleaning Composition

The present invention provides compositions which exhibit improved cleaning of soils (i.e., removal and/or reduction of soils) from and/or care of and/or treatment of leather articles. These benefits may be delivered to the leather article treated by the compositions of the present invention while avoiding damage to the leather article as a result of the treatment.

The treating composition according to the present invention comprises a lipophilic fluid and a treating agent, and optionally, water. When water is present in the treating composition, the treating agent and water may be present in a weight ratio of from about 1 to 0 to about 1 to 100. Optionally, the treating composition may further comprise a leather adjunct. Depending on the desired benefit to be obtained by the compositions of the present invention, the compositions may be considered treating/cleaning compositions, especially if the desired benefit is to remove soils from the leather article. The compositions may be considered replenishing compositions. Treating/cleaning compositions may have relatively more treating agent than leather adjuncts. Replenishing compositions may have relatively more leather adjuncts, especially conditioning and/or waterproofing agents than treating agents.

In one aspect of the present invention, the composition is a 2-in-1 composition (get the benefit of cleaning and replenishing out of one composition) which comprises both treating agent and a leather adjunct, particularly a waterproofing agent.

In one embodiment, the leather article treating composition comprises:

a. from about 0.001% to about 5% of a treating agent;

b. from about 0% to about 2% of water;

c. from about 85% to about 99.999% of a lipophilic fluid;

d. optionally, from about 0% to about 10% of a leather adjunct.

In another embodiment, the treating composition comprises a level of treating agent such that when used in a lipophilic fluid treating composition, the treating agent is present at a level of from about 0.001% to about 2% by weight of the treating composition.

In still another embodiment, the leather article treating composition comprises:

a. from about 0.001% to about 1% by weight of the treating composition of a treating agent; and

b. optionally, water; and

c. optionally, a leather adjunct; and

d. balance, a lipophilic fluid.

In yet another embodiment, the treating composition comprises a treating agent and water in a combined level of from about 0.001% to about 1%, preferably from about 0.001% to about 0.5%, more preferably from about 0.001% to about 0.05% by weight of the treating composition.

In still yet another embodiment, the treating composition of the present invention comprises an effective amount of the treating agent such that the leather article is treated upon being contacted by the treating composition. Typically, the treating agent is present in the treating composition at a level of from about 5% to about 0.001% or from about 3% to about 0.001% or from about 1% to about 0.005% or from about 0.5% to about 0.005% or even from about 0.05% to about 0.005% by weight of the treating composition.

The treating composition may further comprise a solubilizing aid for the treating agent such that the treating agent becomes at least partially soluble in the lipophilic fluid and/or water.

The consumable leather article treating composition may comprise by weight:

a. from about 10% to about 100% of a treating agent;

b. from about 0% to about 60% of water;

c. from about 0% to about 80% of a lipophilic fluid;

d. optionally, from about 10% to about 80% of a leather adjunct.

### Lipophilic Fluid

The lipophilic fluid herein is one having a liquid phase present under operating conditions of a fabric/leather article treating appliance, in other words, during treatment of a fabric article in accordance with the present invention. In general such a lipophilic fluid can be fully liquid at ambient temperature and pressure, can be an easily melted solid, e.g., one which becomes liquid at temperatures in the range from about 0 deg. C. to about 60 deg. C., or can comprise a mixture of liquid and vapor phases at ambient temperatures and pressures, e.g., at 25 deg. C. and 1 atm. pressure. Thus, the lipophilic fluid is not a compressible gas such as carbon dioxide.

It is preferred that the lipophilic fluids herein be nonflammable or have relatively high flash points and/or low VOC (volatile organic compound) characteristics, these terms having their conventional meanings as used in the dry cleaning industry, to equal or, preferably, exceed the characteristics of known conventional dry cleaning fluids.

Moreover, suitable lipophilic fluids herein are readily flowable and nonviscous.

In general, lipophilic fluids herein are required to be fluids capable of at least partially dissolving sebum or body soil as defined in the test hereinafter. Mixtures of lipophilic fluid are also suitable, and provided that the requirements of the Lipophilic Fluid Test, as described below, are met, the lipophilic fluid can include any fraction of dry-cleaning solvents, especially newer types including fluorinated solvents, or perfluorinated amines. Some perfluorinated amines such as perfluorotributylamines while unsuitable for use as lipophilic fluid may be present as one of many possible adjuncts present in the lipophilic fluid-containing composition.

Other suitable lipophilic fluids include, but are not limited to, diol solvent systems e.g., higher diols such as C6- or C8- or higher diols, organosilicone solvents including both cyclic and acyclic types, and the like, and mixtures thereof.

A preferred group of nonaqueous lipophilic fluids suitable for incorporation as a major component of the compositions of the present invention include low-volatility nonfluorinated organics, silicones, especially those other than amino functional silicones, and mixtures thereof. Low volatility nonfluorinated organics include for example OLEAN® and other polyol esters, or certain relatively nonvolatile biodegradable mid-chain branched petroleum fractions.

Another preferred group of nonaqueous lipophilic fluids suitable for incorporation as a major component of the compositions of the present invention include, but are not limited to, glycol ethers, for example propylene glycol methyl ether, propylene glycol n-propyl ether, propylene glycol t-butyl ether, propylene glycol n-butyl ether, dipropylene glycol methyl ether, dipropylene glycol n-propyl ether, dipropylene glycol t-butyl ether, dipropylene glycol n-butyl ether, tripropylene glycol methyl ether, tripropylene glycol n-propyl ether, tripropylene glycol t-butyl ether, tripropylene glycol n-butyl ether. Suitable silicones for use as a major component, e.g., more than 50%, of the composition include cyclopentasiloxanes, sometimes termed “D5”, and/or linear analogs having approximately similar volatility, optionally complemented by other compatible silicones. Suitable silicones are well known in the literature, see, for example, Kirk Othmer's Encyclopedia of Chemical Technology, and are available from a number of commercial sources, including General Electric, Toshiba Silicone, Bayer, and Dow Corning. Other suitable lipophilic fluids are commercially available from Procter & Gamble or from Dow Chemical and other suppliers.

### Qualification of Lipophilic Fluid and Lipophilic Fluid Test (LF Test)

Any nonaqueous fluid that is both capable of meeting known requirements for a dry-cleaning fluid (e.g., flash point etc.) and is capable of at least partially dissolving sebum, as indicated by the test method described below, is suitable as a lipophilic fluid herein. As a general guideline, perfluorobutylamine (Fluorinert FC-43®) on its own (with or without adjuncts) is a reference material which by definition is unsuitable as a lipophilic fluid for use herein (it is essentially a nonsolvent) while cyclopentasiloxanes have suitable sebum-dissolving properties and dissolves sebum.

The following is the method for investigating and qualifying other materials, e.g., other low-viscosity, free-flowing silicones, for use as the lipophilic fluid. The method uses commercially available Crisco® canola oil, oleic acid (95% pure, available from Sigma Aldrich Co.) and squalene (99% pure, available from J. T. Baker) as model soils for sebum. The test materials should be substantially anhydrous and free from any added adjuncts, or other materials during evaluation.

Prepare three vials, each vial will contain one type of lipophilic soil. Place 1.0 g of canola oil in the first; in a second vial place 1.0 g of the oleic acid (95%), and in a third and final vial place 1.0 g of the squalene (99.9%). To each vial add 1 g of the fluid to be tested for lipophilicity. Separately mix at room temperature and pressure each vial containing the lipophilic soil and the fluid to be tested for 20 seconds on a standard vortex mixer at maximum setting. Place vials on the bench and allow to settle for 15 minutes at room temperature and pressure. If, upon standing, a clear single phase is formed in any of the vials containing lipophilic soils, then the nonaqueous fluid qualifies as suitable for use as a “lipophilic fluid” in accordance with the present invention. However, if two or more separate layers are formed in all three vials, then the amount of nonaqueous fluid dissolved in the oil phase will need to be further determined before rejecting or accepting the nonaqueous fluid as qualified.

In such a case, with a syringe, carefully extract a 200-microliter sample from each layer in each vial. The syringe-extracted layer samples are placed in GC auto sampler vials and subjected to conventional GC analysis after determining the retention time of calibration samples of each of the three models soils and the fluid being tested. If more than 1% of the test fluid by GC, preferably greater, is found to be present in any one of the layers which consists of the oleic acid, canola oil or squalene layer, then the test fluid is also qualified for use as a lipophilic fluid. If needed, the method can be further calibrated using heptacosafluorotributylamine, i.e., Fluorinert FC-43 (fail) and cyclopentasiloxane (pass). A suitable GC is a Hewlett Packard Gas Chromatograph HP5890 Series II equipped with a split/splitless injector and FID. A suitable column used in determining the amount of lipophilic fluid present is a J&W Scientific capillary column DB-1HT, 30 meter, 0.25 mm id, 0.1 um film thickness cat# 1221131. The GC is suitably operated under the following conditions:

Carrier Gas: Hydrogen

Column Head Pressure: 9 psi

Flows: Column Flow @˜1.5 ml/min.
Split Vent @˜250-500 ml/min.
Septum Purge @1 ml/min.

Injection: HP 7673 Autosampler, 10 ul syringe, 1 ul injection

Injector Temperature: 350° C.

Detector Temperature: 380° C.

Oven Temperature Program: initial 60° C. hold 1 min.
rate 25° C./min.
final 380° C. hold 30 min.

Preferred lipophilic fluids suitable for use herein can further be qualified for use on the basis of having an excellent garment care profile. Garment care profile testing is well known in the art and involves testing a fluid to be qualified using a wide range of garment or fabric article components, including fabrics, threads and elastics used in seams, etc., and a range of buttons. Preferred lipophilic fluids for use herein have an excellent garment care profile, for example they have a good shrinkage and/or fabric puckering profile and do not appreciably damage plastic buttons. Certain materials which in sebum removal qualify for use as lipophilic fluids, for example ethyl lactate, can be quite objectionable in their tendency to dissolve buttons, and if such a material is to be used in the compositions of the present invention, it will be formulated with water and/or other solvents such that the overall mix is not substantially damaging to buttons. Other lipophilic fluids, D5, for example, meet the garment care requirements quite admirably. Some suitable lipophilic fluids may be found in granted U.S. Pat. Nos. 5,865,852; 5,942,007; 6,042,617; 6,042,618; 6,056,789; 6,059,845; and 6,063,135, which are incorporated herein by reference.

Lipophilic fluids can include linear and cyclic polysiloxanes, hydrocarbons and chlorinated hydrocarbons, with the exception of PERC and DF2000 which are explicitly not covered by the lipophilic fluid definition as used herein. More preferred are the linear and cyclic polysiloxanes and hydrocarbons of the glycol ether, acetate ester, lactate ester families. Preferred lipophilic fluids include cyclic siloxanes having a boiling point at 760 mm Hg. of below about 250° C. Specifically preferred cyclic siloxanes for use in this invention are octamethylcyclotetrasiloxane, decamethylcyclopentasiloxane, and dodecamethylcyclohexasiloxane. Preferably, the cyclic siloxane comprises decamethylcyclopentasiloxane (D5, pentamer) and is substantially free of octamethylcyclotetrasiloxane (tetramer) and dodecamethylcyclohexasiloxane (hexamer).

However, it should be understood that useful cyclic siloxane mixtures might contain, in addition to the preferred cyclic siloxanes, minor amounts of other cyclic siloxanes including octamethylcyclotetrasiloxane and hexamethylcyclotrisiloxane or higher cyclics such as tetradecamethylcycloheptasiloxane. Generally the amount of these other cyclic siloxanes in useful cyclic siloxane mixtures will be less than about 10 percent based on the total weight of the mixture. The industry standard for cyclic siloxane mixtures is that such mixtures comprise less than about 1% by weight of the mixture of octamethylcyclotetrasiloxane.

Accordingly, the lipophilic fluid of the present invention preferably comprises more than about 50%, more preferably more than about 75%, even more preferably at least about 90%, most preferably at least about 95% by weight of the lipophilic fluid of decamethylcyclopentasiloxane. Alternatively, the lipophilic fluid may comprise siloxanes which are a mixture of cyclic siloxanes having more than about 50%, preferably more than about 75%, more preferably at least about 90%, most preferably at least about 95% up to about 100% by weight of the mixture of decamethylcyclopentasiloxane and less than about 10%, preferably less than about 5%, more preferably less than about 2%, even more preferably less than about 1%, most preferably less than about 0.5% to about 0% by weight of the mixture of octamethylcyclotetrasiloxane and/or dodecamethylcyclohexasiloxane.

The level of lipophilic fluid, when present in the treating compositions according to the present invention, is preferably from about 70% to about 99.99%, more preferably from about 90% to about 99.9%, and even more preferably from about 95% to about 99.8% by weight of the treating composition.

The level of lipophilic fluid, when present in the consumable leather article treating/cleaning compositions according to the present invention, is preferably from about 0.1% to about 90%, more preferably from about 0.5% to about 75%, and even more preferably from about 1% to about 50% by weight of the consumable leather article treating/cleaning composition.

### Treating Agents

Suitable treating agents for use in the treating compositions of the present invention include, but are not limited to, surfactants, other cleaning agents, and other benefit agents.

In one embodiment, the treating agent is insoluble in water. In another embodiment, the treating agent is insoluble in water, but soluble in a lipophilic fluid. In yet another embodiment, the treating agent is insoluble in water, soluble in a lipophilic fluid and has an HLB of from about 1 to about 9 or from about 1 to about 7 or from about 1 to about 5.

The treating agent, even though it is insoluble in water, may have a hydrophobic component and a hydrophilic component. The hydrophobic component may comprise a hydrophobic moiety selected from the group consisting of: linear or branched, substituted or unsubstituted hydrocarbon and/or siloxane moieties and mixtures thereof. The hydrophilic component may comprise a hydrophilic moiety selected from the group consisting of: alkoxylate (i.e., ethoxylate, propoxylate, butoxylate, etc.), carboxylate, hydroxy, carbonyl, amine, sulfonate, sulfate, amine oxide and phosphate moieties and mixtures thereof.

The treating agent may comprise one or more of the following properties:

a. a propoxy or greater alkoxy group;

b. a molar ratio of ethoxy group to propoxy or greater alkoxy group of less than about 1:1, preferably less than about 2:5, more preferably less than about 1:5, even more preferably less than about 1:10;

c. a silicon moiety;

d. an HLB of less than about 9, preferably less than about 7, more preferably less than about 5;

e. an OH substituent;

f. comprising no charged substituent;

g. no nitrogen-containing moiety; and

h. mixtures thereof.

The treating agent may have the formula:

R—X

wherein R is a linear or branched, substituted or unsubstituted, hydrocarbon moiety; and X is a propoxy or greater alkoxy group.

In still another embodiment, the treating agent is insoluble in water and insoluble in a lipophilic fluid. In still yet another embodiment, the treating agent in conjunction with a solubilizing agent is at least partially soluble in a lipophilic fluid and/or water. In the solubilizing agent embodiment, the treating agent is present at a level in the treating composition at from about 0.001% to about 5% or from about 0.001% to about 3% or from about 0.001% to about 1% by weight of the treating composition.

One class of materials can include siloxane-based surfactants (siloxane-based materials). The siloxane-based surfactants in this application may be siloxane polymers for other applications. The siloxane-based surfactants typically have a weight average molecular weight from 500 to 20,000. Such materials, derived from poly(dimethylsiloxane), are well known in the art. In the present invention, not all such siloxane-based surfactants are suitable, because they do not provide improved cleaning of soils compared to the level of cleaning provided by the lipophilic fluid itself.

Suitable siloxane-based surfactants comprise a polyether siloxane having the formula:

MₐD_{b}D′_{c}D″_{d}M′₂₋ₐ

wherein a is 0-2; b is 0-1000; c is 0-50; d is 0-50, provided that a+c+d is at least 1;

M is R¹₃₋ₑXₑSiO_{1/2} wherein R¹ is independently H, or a monovalent hydrocarbon group, X is hydroxyl group, and e is 0 or 1;

M′ is R²₃SiO_{1/2} wherein R² is independently H, a monovalent hydrocarbon group, or (CH₂)_{f}—(C6H₄)_{g}O—(C₂H₄O)ₕ—(C₃H₆O)ᵢ—(CₖH₂ₖO)ⱼ—R³, provided that at least one R² is (CH₂)_{f}—(C6H₄)_{g} O—(C₂H₄O)ₕ—(C₃H₆O)ᵢ—(CₖH₂ₖO)ⱼ—R³, wherein R³ is independently H, a monovalent hydrocarbon group or an alkoxy group, f is 1-10, g is 0 or 1, h is 1-50, i is 0-50, j is 0-50, k is 4-8;

D is R⁴₂SiO_{2/2} wherein R⁴ is independently H or a monovalent hydrocarbon group;

D′ is R⁵₂SiO_{2/2} wherein R⁵ is independently R² provided that at least one R⁵ is (CH₂)_{f}—(C6H₄)_{g} O—(C₂H₄O)ₕ—(C₃H₆O)ᵢ—(CₖH₂ₖO)ⱼ—R³, wherein R³ is independently H, a monovalent hydrocarbon group or an alkoxy group, f is 1-10, g is 0 or 1, h is 1-50, i is 0-50, j is 0-50, k is 4-8; and

D″ is R⁶₂SiO_{2/2} wherein R⁶ is independently H, a monovalent hydrocarbon group or (CH₂)ₗ(C₆H₄)ₘ(A)ₙ-[(L)ₒ-(A′)ₚ-]_{q}-(L′)ᵣZ(G)ₛ, wherein 1 is 1-10; m is 0 or 1; n is 0-5; o is 0-3; p is 0 or 1; q is 0-10; r is 0-3; s is 0-3; C₆H₄ is unsubstituted or substituted with a C₁₋₁₀ alkyl or alkenyl; A and A′ are each independently a linking moiety representing an ester, a keto, an ether, a thio, an amido, an amino, a C₁₋₄ fluoroalkyl, a C₁₋₄ fluoroalkenyl, a branched or straight chained polyalkylene oxide, a phosphate, a sulfonyl, a sulfate, an ammonium, and mixtures thereof; L and L′ are each independently a C₁₋₃₀ straight chained or branched alkyl or alkenyl or an aryl which is unsubstituted or substituted; Z is a hydrogen, carboxylic acid, a hydroxy, a phosphato, a phosphate ester, a sulfonyl, a sulfonate, a sulfate, a branched or straight-chained polyalkylene oxide, a nitril, a glyceryl, an aryl unsubstituted or substituted with a C₁₋₃₀alkyl or alkenyl, a carbohydrate unsubstituted or substituted with a C₁₋₁₀alkyl or alkenyl or an ammonium; G is an anion or cation such as H⁺, Na⁺, Li⁺, K⁺, NH₄⁺, Ca⁺², Mg⁺², Cl⁻, Br⁻, I⁻, mesylate or tosylate.

Examples of the types of siloxane-based surfactants described herein above may be found in EP-1,043,443A1, EP-1,041,189 and WO-01/34,706 (all to GE Silicones) and U.S. Pat. No. 5,676,705, U.S. Pat. No. 5,683,977, U.S. Pat. No. 5,683,473, and EP-1,092,803A1 (all to Lever Brothers).

The treating agent, when present in the leather article treating/cleaning compositions of the present invention, preferably comprises from about 0.01% to about 10%, more preferably from about 0.02% to about 5%, even more preferably from about 0.05% to about 2% by weight of the leather article treating/cleaning composition.

The treating agent, when present in the consumable leather article treating/cleaning compositions of the present invention, preferably comprises from about 1% to about 99%, more preferably 2% to about 75%, even more preferably from about 5% to about 60% by weight of the consumable leather article treating/cleaning composition.

Nonlimiting examples of suitable treating agents include treating agents commercially available from Dow Corning under tradenames such as Dow Corning 1248, and oleic acid and the following as less preferred but still suitable SF1528 DC5225C and DCQ4 3667; and Silwets from Witco under tradenames such as L8620, L7210, L7220.

### Water

Optionally, compositions according to the present invention may contain water.

Water, when present in the leather article treating/cleaning compositions of the present invention, preferably comprises from about 0.001% to about 5%, more preferably from about 0.005% to about 5%, even more preferably from about 0.01% to about 1% by weight of the leather article treating composition.

Water, when present in the consumable leather article treating/cleaning compositions of the present invention, preferably comprises from about 0% to about 80%, more preferably from about 1% to about 75%, even more preferably from about 5% to about 40% by weight of the consumable leather article treating/cleaning composition.

Water, if any, may be added separately to the leather article treating apparatus to form the leather article treating composition rather than being present in the consumable leather article treating composition.

### Leather Adjuncts

The treating compositions of the present invention optionally comprise a leather adjunct. Nonlimiting examples of leather adjuncts include conditioning agents (including fat liquoring agents), perfumes, waterproofing agents, dye transfer inhibiting agents, dye fixating agents, and tanning agents.

### Conditioning Agents

Silicone compounds are well known for their lubrication capabilities. Either unmodified PDMS (PolyDiMethyl Siloxane) or organo-PDMS can be used for the present invention. Nonlimiting examples include GE CM2233, SM2658, or Dow Corning 51. Additionally, polyalkyleneoxide modified polydimethylsiloxane available under the tradename SILWET-7500 from Osi Specialties can also be used in the treating compositions of the present invention.

Fatliquoring agents are historically used in the tanning industry to soften the leather. They generally are vegetable, animal and marine fats or a blend of these. Often it is partially sulfated or sulfonated so that it can be dispersed evenly in an aqueous medium and penetrate leather effectively. Sometimes surfactants are added to emulsify the oil. Nonlimiting examples of the fatliquors are Chemol 45 and Chemol 130 by Chemtan Co.

One class of particularly effective fat liquoring agents is the amidocarboxysilicones see (U.S. Pat. No. 6,110,230, BASF) are used instead of conventional silicones (aminosilicones) for the fat liquoring and/or waterproofing of leather during an immersive cleaning process wherein the solvent or washing fluid is primarily composed of D5. These may also be used as waterproofing agents in the present invention.

Suitable fluorocarbon polymers include, but are not limited to, Repearl F84, Repearl F89 and Repearl F3700 fluoropolymers from Mitsubishi International Corp.

Suitable quaternary ammonium compounds useful as conditioning agents include, but are not limited to, Ditallow Dimethyl Ammonium Chloride.

Commercial lecithins, or phospholipid compounds are used to soften and cure leathers. It also can be used as an emulsifying agent during the fatliquoring step to aid the penetration of fatliquor compounds. Nonlimiting examples of such materials are Centrolene A and Centrophase HR2B commercially available from Central Soya Company.

Suitable sucrose esters of fatty acids can be used as fat substitutes to lubricate the shoe surfaces, especially leather-containing shoe surfaces.

Conditioning agents can be applied either as part of the cleaner (2 in 1) or added separately. When applied separately, the conditioning agents can be added as a pre-treat composition which is applied to a leather article prior to treating the leather article according to the processes of the present invention. Further, one or more conditioning agents may be applied to a leather article via a treating composition containing the conditioning agents during treatment of the leather article (i.e., “Through the Wash”). Further yet, one or more conditioning agents may be applied to a leather article after treatment of the leather article (i.e., post-treat).

The mode of delivery of the leather adjuncts is important to the effective and efficient use in this process. The preferred method of delivery is via the D5 treating solution. As such it is further preferred that the leather adjuncts be soluble or dispersible in D5 so that they be efficiently delivered in the D5.

In general, the leather adjuncts may be delivered either with the treating composition or before or after the treating composition or a combination of any or all three.

It is possible that a rinse process may be robust enough to remove the any leather adjuncts delivered in a main wash. Therefore, the inclusion of the leather adjuncts in the rinse may be desirable.

Alternatively the benefit agents may be applied to the leather garments either before or after the cleaning process.

### Waterproofing Agents

The compositions of the present invention may also comprise waterproofing agents. Nonlimiting examples of suitable waterproofing agents include Densodrin SI commercially available from BASF; Lubritan AS commercially available from Rohm & Haas; epoxysilicones, especially under the tradenames UV9400 and UV9315 both of which are commercially available from GE Silicones. Waterproofing agents may also function as conditioning agents. Their functions are dependent upon when they are used and the desired benefit to be obtained. For example Densodrin SI and Lubritan AS may function both as a waterproofing agent as well as conditioning agents in accordance with the present invention.

### Perfumes

The compositions of the present invention may also comprise one or more perfumes. Suitable perfumes are soluble in the lipophilic fluid. In one embodiment, the composition comprises a perfume that is soluble in the lipophilic fluid at up to about 10% by weight of the lipophilic fluid.

### Processes of the Present Invention

Often surfactants and water are used in the lipophilic fluid cleaning of non-leather clothing. In order to provide superior performance in the leather care and/or cleaning processes of the present invention, it is desirable to remove and/or reduce the contaminants, such as residual water and/or surfactant from the lipophilic fluid prior to contacting a leather article with the recycled lipophilic fluid. It is further envisaged that the process could include a step of priming the lines and rinsing the drum with distilled or otherwise purified lipophilic fluid from possible contaminants (water, surfactant, other) to assure cleanliness of the system prior to the wash.

In one embodiment, a leather article treating process is provided wherein a leather article is treated in an apparatus that has been used previously to treat non-leather fabric articles by contacting the non-leather fabric articles with a non-leather fabric article treating agents that are capable of damaging the leather article, the process comprising the steps of:

a. removing from and/or reducing the level present in the apparatus of the non-leather fabric article treating agents that are capable of damaging the leather article;

b. placing the leather article into the apparatus;

c. contacting the leather article with a treating composition comprising a lipophilic fluid and a treating agent wherein the treating agent is insoluble in water such that the appearance of the leather article is not damaged compared to its original appearance prior to contacting with the treating composition; and

d. optionally, contacting the treated leather article from Step (c) with a replenishing composition; and

e. optionally, drying the leather article; and

f. optionally, removing the leather article from the apparatus.

The treatment process will utilize wash time of at least 1 min, more preferred 10 min, and even more preferred 20 min, but no longer than 90 min, more preferred no longer than 40 min. The benefit of longer exposure to the treating systems is well known. However, that benefit must be balanced against the potential damage to leather caused by excessive mechanical agitation in the washing machine. In general, longer wash time could be used with gentler agitation.

It may be desired that cleaning agents not remain either on the surface of the leather or in the leather. In this case it is preferred that the treatment of the leather with the treating composition be followed by a treatment with the lipophilic fluid and preferably with the leather adjunct.

After the leather is treated either with or without a rinse, the D5 must be substantially removed form the garment. As in the case of treating leather with D5, there is no adequate description of how dry leather such that the objectives of the invention are met.

Typically, when leather (especially garments or other article of clothing) is dry cleaned in D5, it must be dried (D5 removed) to levels that will leave no visible D5 residue or D5 odor. The D5 drying of leather can be slow compared the water drying of D5 primarily due to its higher boiling point. Other garments types (e.g., cotton) require lower temperatures than leather to D5 dry. However, unlike many other fabrics leather can be especially sensitive to heat. Vegetable and (to a lesser extent) syn tanned leathers are even more temperature sensitive than chrome tanned leather. It is therefore essential to meet the objectives of the invention that the drying is done such that the leather is quickly dried without concomitant damage to the leather.

Therefore a preferred process for drying leather garments is given wherein the dryer temperature is between about 25 C and about 75 C, more preferably between 35 C and 65 C. A reduced vacuum is also preferred so as to lower the temperature range required to achieve a satisfactory drying result or conversely lower the drying time at a given temperature. A similarly preferred variation occurs when the D5 contacting the leather in last cycle is preheated such that the leather is more effectively dried than if the leather is heated via air heating. This is particularly useful in conjunction with the either forced air or vacuum drying or a combination of the two.

As noted above, the drying of D5-treated leather can be slow compared to the drying of water-treated leather because the vapor pressure of D5 is lower than that of water at the same dryer temperatures. Thus water will be more quickly removed from leather than D5. Water is a critical element of leather and excessive removal of water can greatly damage leather. Thus the drying of leather to low levels of D5 could water dry the leather to levels of water that could damage the leather. This can be especially problematic in low relative humidity situations such as winter or in air-conditioned building wherein the cooling processes lower the relative humidity. In order to lessen or ameliorate this problem, a process for cleaning leather with D5 (or any solvent system whose boiling point with equal to or greater than that for water) wherein the water is replenished into the leather in a non-destructive manner. The methods could include maintaining an adequate vapor pressure of water in the dryer such that the removal of water is reduced or slowed to an inconsequential rate or misting/steaming the leather during the drying process or after the drying process. Similarly, the loss of water may (partially or completed) be ameliorated by treating the leather with fat liquoring or other leather conditioning agents. It is recognized that in general is unlikely that the loss of water can be completely remedied by the addition of fat liquoring or other conditioning agents. Rather, the use of the fat liquoring agents can lessen the need for complete replenishment of the water, thus making the process more flexible and easier to do.

Similar improvements are contemplated for yet another improvement to the drying process. As noted above, when leather (especially garments or other article of clothing) is dry cleaned in D5, it must be dried (D5 removed) to levels that will leave no visible residue or odor. It is convenient to have a “shut off” device, apparatus or mechanism so as to not overheat or over dry. Often, for D5 drying of (cotton, rayon, polyester, silk, etc) fabric, the D5 sensor detects the bulk D5 as it is condensed. Because leather typically D5 dries much more slowly than the above typical fabrics, the drier may shut off prematurely due to the slow release of D5 form the leather. That is, the dryer will shut off before the desired level of D5 drying is achieved. Similarly, drying without a shut off device and also lead to over drying in which too much water is removed which may damage the leather. Therefore, yet another preferred process for drying leather utilizes a D5 detection system that detects D5 at lower levels than those typically used for fabric garments. Typically, it preferred that the detector and shutoff system detect D5 from 1000 ppm to 0.01 ppm, preferably from 100 ppm to 0.1 ppm and more preferably from 50 ppm to 1 ppm

Because the leather articles may be treated in systems wherein non-optimal solutions or solutions harmful to leather may be encountered, a process wherein the D5 is purified and the systems are flushed of the solutions harmful to leather is highly desirable. Such a process could include a step of priming the lines and rinsing the drum from possible contaminants to assure cleanliness of the system prior to the treatment.

The treatment process will also utilize a contact time of at least 1 min, more preferred 10 min, and even more preferred 20 min, but no longer than 90 min, more preferred no longer than 40 min.

A process for treating leather and suede garments which utilizes a carbon filter to trap the dyes may also be used. It is preferred that filter is continuously employed throughout the wash cycle to minimize possible dye transfer onto garments.

### EXAMPLES

### Example 1

The following is a non-limiting example of a leather article treating composition in accordance with the present invention.

TABLE 1

| Ingredient | By weight |
|---|---|
| D5 | 80-99.9% |
| Treating Agent | 0.001-5% |
| Water | 0-5% |
| Leather Adjunct | 0-10% |

### Example 2

The following is a non-limiting example of a consumable leather article treating composition in accordance with the present invention.

TABLE 1

| Ingredient | By weight |
|---|---|
| D5 | 0-99% |
| Treating Agent | 1-100% |
| Water | 0-99% |
| Leather Adjunct | 0-99% |

What is claimed is:

1. A process for treating a leather article comprising the step of contacting the leather article with a treating composition comprising a lipophilic fluid and a treating agent wherein the treating agent is insoluble in water such that the appearance of the leather article is not damaged compared to its original appearance prior to contacting with the treating composition.

2. The process according to claim 1 wherein the lipophilic fluid comprises a siloxane.

3. The process according to claim 1 wherein the treating agent is insoluble in the lipophilic fluid.

4. The process according to claim 3 wherein the treating composition further comprises a solubilizing aid for the treating agent such that the treating agent becomes at least partially soluble in the lipophilic fluid and/or water, if any is present in the treating composition, then the treating agent comprises one or more of the following properties:
a. a propoxy or greater alkoxy group;
b. a molar ratio of ethoxy group to propoxy or greater alkoxy group of less than about 1:1;
c. a silicon moiety;
d. an HLB of less than about 9;
e. an OH substituent;
f. comprising no charged substituent;
g. no nitrogen-containing moiety; and
h. mixtures thereof.

5. The process according to claim 1 wherein the treating agent is soluble in the lipophilic fluid.

6. The process according to claim 5 wherein the treating agent comprises one or more of the following properties:
a. a propoxy or greater alkoxy group;
b. a molar ratio of ethoxy group to propoxy or greater alkoxy group of less than about 1:1;
c. a silicon moiety;
d. an HLB of less than about 9;
e. an OH substituent;
f. comprising no charged substituent;
g. no nitrogen-containing moiety; and
h. mixtures thereof.

7. The process according to claim 5 wherein when the treating composition further comprises water, the treating agent is either present in the treating composition at a level of less than about 5% by weight of the treating composition and/or the treating agent comprises one or more of the following properties:
a. a propoxy or greater alkoxy group;
b. a molar ratio of ethoxy group to propoxy or greater alkoxy group of less than about 1:1;
c. a silicon moiety;
d. an HLB of less than about 9;
e. an OH substituent;
f. comprising no charged substituent;
g. no nitrogen-containing moiety; and
h. mixtures thereof.

8. The process according to claim 1 wherein the treating agent has the formula:
R—X
wherein R is a linear or branched, substituted or unsubstituted, hydrocarbon moiety; and X is a propoxy or greater alkoxy group.

9. The process according to claim 1 wherein the treating agent has the formula:
MₐD_{b}D′_{c}D″_{d}M′₂₋ₐ
wherein a is 0-2; b is 0-1000; c is 0-50; d is 0-50, provided that a+c+d is at least 1;
M is R¹₃₋ₑXₑSiO_{1/2} wherein R¹ is independently H, or a monovalent hydrocarbon group, X is hydroxyl group, and e is 0 or 1;
M′ is R²₃SiO_{1/2} wherein R² is independently H, a monovalent hydrocarbon group, or (CH₂)_{f}—(C6H₄)_{g}O—(C₂H₄O)ₕ—(C₃H₆O)ᵢ—(CₖH₂ₖO)ⱼ—R³, provided that at least one R² is (CH₂)_{f}—(C6H₄)_{g} O—(C₂H₄O)ₕ—(C₃H₆O)ᵢ—(CₖH₂ₖO)ⱼ—R³, wherein R³ is independently H, a monovalent hydrocarbon group or an alkoxy group, f is 1-10, g is 0 or 1, h is 1-50, i is 0-50, j is 0-50, k is 4-8;
D is R⁴₂SiO_{2/2} wherein R⁴ is independently H or a monovalent hydrocarbon group;
D′ is R⁵₂SiO_{2/2} wherein R⁵ is independently R² provided that at least one R⁵ is (CH₂)_{f}—(C6H₄)_{g} O—(C₂H₄O)ₕ—(C₃H₆O)ᵢ—(CₖH₂ₖO)ⱼ—R³, wherein R³ is independently H, a monovalent hydrocarbon group or an alkoxy group, f is 1-10, g is 0 or 1, h is 1-50, i is 0-50, j is 0-50, k is 4-8; and
D″ is R⁶₂SiO_{2/2} wherein R⁶ is independently H, a monovalent hydrocarbon group or (CH₂)ₗ(C₆H₄)ₘ(A)ₙ-[(L)ₒ-(A′)ₚ-]_{q}-(L′)ᵣZ(G)ₛ, wherein 1 is 1-10; m is 0 or 1; n is 0-5; o is 0-3; p is 0 or 1; q is 0-10; r is 0-3; s is 0-3; C₆H₄ is unsubstituted or substituted with a C₁₋₁₀ alkyl or alkenyl; A and A′ are each independently a linking moiety representing an ester, a keto, an ether, a thio, an amido, an amino, a C₁₋₄ fluoroalkyl, a C₁₋₄ fluoroalkenyl, a branched or straight chained polyalkylene oxide, a phosphate, a sulfonyl, a sulfate, an ammonium, and mixtures thereof; L and L′ are each independently a C₁₋₃₀ straight chained or branched alkyl or alkenyl or an aryl which is unsubstituted or substituted; Z is a hydrogen, carboxylic acid, a hydroxy, a phosphato, a phosphate ester, a sulfonyl, a sulfonate, a sulfate, a branched or straight-chained polyalkylene oxide, a nitryl, a glyceryl, an aryl unsubstituted or substituted with a C₁₋₃₀alkyl or alkenyl, a carbohydrate unsubstituted or substituted with a C₁₋₁₀alkyl or alkenyl or an ammonium; G is an anion or cation such as H⁺, Na⁺, Li⁺, K⁺, NH₄⁺, Ca⁺², Mg⁺², Cl⁻, Br⁻, I⁻, mesylate or tosylate.

10. The process according to claim 1 wherein the treating composition further comprises a leather adjunct selected from the group consisting of: perfumes, waterproofing agents, dye transfer inhibiting agents, dye fixating agents, conditioning agents, tanning agents and mixtures thereof.

11. The process according to claim 1 wherein the treating agent is releasably attached to a carrier.

12. The process according to claim 11 wherein the carrier is in the form of a non-woven sheet.

13. The process according to claim 12 wherein the lipophilic fluid comprises a siloxane.

14. The process according to claim 1 wherein the treating composition further comprises water.

15. The process according to claim 13 wherein the treating agent and water are present in the treating composition at a weight ratio of from about 1 to 0 to about 1 to 100.

16. The process according to claim 14 wherein the treating composition is formed in-situ by in-situ ingredients selected from the group consisting of: the treating agent, the lipophilic fluid and water.

17. The process according to claim 16 wherein one or more of the in-situ ingredients is delivered by a carrier.

18. The process according to claim 1 wherein the treating agent comprises a hydrophobic component and a hydrophilic component.

19. The process according to claim 1 wherein the leather article is a finished leather article.

20. The process according to claim 1 wherein the process further comprises the step of contacting the leather article with a replenishing composition.

21. The process according to claim 20 wherein the step of contacting the leather article with the replenishing composition is subsequent to the step of contacting the leather article with the treating composition.

22. The process according to claim 20 wherein the step of contacting the treated leather article with the replenishing composition substantially restores the leather article's original physical condition.

23. The process according to claim 20 wherein the replenishing composition comprises a replenishing agent selected from the group consisting of: lipophilic fluids, water, fat liquoring agents and mixtures thereof.

24. The process according to claim 23 wherein the replenishing composition further comprises a leather adjunct selected from the group consisting of: perfumes, waterproofing agents, dye transfer inhibiting agents, dye fixating agents, conditioning agents, tanning agents and mixtures thereof.

25. The process according to claim 20 wherein the replenishing composition is delivered to the leather article in the form of a spray and/or mist and/or steam such that the original appearance of the leather article is substantially restored.

26. The process according to claim 1 wherein the process further comprises the step of pre-treating the leather article with a pre-treating composition comprising a lipophilic fluid prior to contacting the leather article with the treating composition.

27. The process according to claim 1 wherein the process further comprises the step of drying the leather article by exposing the leather article to a temperature of from about 25° C. to about 75° C. subsequent to contacting the leather article with the treating composition.

28. The process according to claim 20 wherein the process further comprises the step of drying the leather article by exposing the leather article to a temperature of from about 25° C. to about 75° C. subsequent to contacting the leather article with the replenishing composition.

29. The process according to claim 1 wherein the leather article is a soiled leather article, wherein the soil is removed and/or reduced from the leather article.

30. A leather article treated by the process according to claim 1.

31. A leather article treated by the process according to claim 20

32. A leather article treating composition comprising:
a. from about 0.001% to about 5% of a treating agent;
b. from about 0% to about 5% of water;
c. from about 85% to about 99.999% of a lipophilic fluid;
d. optionally, from about 0% to about 10% of a leather adjunct.

33. A consumable leather article treating composition comprising a level of treating agent such that when used in a lipophilic fluid treating composition, the treating agent is present at a level of from about 0.001% to about 5% by weight of the treating composition.

34. A leather article treating process wherein the leather article is treated in an apparatus that has been used previously to treat non-leather fabric articles by contacting the non-leather fabric articles with a non-leather fabric article treating agents that are capable of damaging the leather article, the process comprising the steps of:
a. removing from and/or reducing the level present in the apparatus of the non-leather fabric article treating agents that are capable of damaging the leather article;
b. placing the leather article into the apparatus;
c. contacting the leather article with a treating composition comprising a lipophilic fluid and a treating agent wherein the treating agent is insoluble in water such that the appearance of the leather article is not damaged compared to its original appearance prior to contacting with the treating composition; and
d. optionally, contacting the treated leather article from Step (c) with a replenishing composition; and
e. optionally, drying the leather article; and
f. optionally, removing the leather article from the apparatus.

35. A process for treating a leather article comprising the step of contacting the leather article with a treating composition comprising:
a. from about 0.001% to about 1% by weight of the treating composition of a treating agent; and
b. optionally, water; and
c. optionally, a leather adjunct; and
d. balance, a lipophilic fluid.

36. The process according to claim 35 wherein the treating composition comprises the treating agent and water in a combined level of from about 0.001 to about 1% by weight of the treating composition.

37. The process according to claim 35 wherein the lipophilic fluid comprises a siloxane.

38. The process according to claim 35 wherein the treating agent is insoluble in the lipophilic fluid.

39. The process according to claim 38 wherein the treating composition further comprises a solubilizing aid for the treating agent such that the treating agent becomes at least partially soluble in the lipophilic fluid and/or water, if any is present in the treating composition, then the treating agent comprises one or more of the following properties:
a. a propoxy or greater alkoxy group;
b. a molar ratio of ethoxy group to propoxy or greater alkoxy group of less than about 1:1;
c. a silicon moiety;
d. an HLB of less than about 9;
e. an OH substituent;
f. comprising no charged substituent;
g. no nitrogen-containing moiety; and
h. mixtures thereof.

40. The process according to claim 35 wherein the treating agent is soluble in the lipophilic fluid.

41. The process according to claim 40 wherein the treating agent comprises one or more of the following properties:
a. a propoxy or greater alkoxy group;
b. a molar ratio of ethoxy group to propoxy or greater alkoxy group of less than about 1:1;
c. a silicon moiety;
d. an HLB of less than about 9;
e. an OH substituent;
f. a non-charged substituent;
g. no nitrogen-containing moiety; and
h. mixtures thereof.

42. The process according to claim 40 wherein the treating composition further comprises water, then the treating agent is either present in the treating composition at a level of less than about 5% by weight of the treating composition, or the treating agent comprises one or more of the following properties:
a. a propoxy or greater alkoxy group;
b. a molar ratio of ethoxy group to propoxy or greater alkoxy group of less than about 1:1;
c. a silicon moiety;
d. an HLB of less than about 9;
e. an OH substituent;
f. a non-charged substituent;
g. no nitrogen-containing moiety; and
h. mixtures thereof.

43. The process according to claim 35 wherein the treating agent has the formula:
R—X
wherein R is a linear or branched, substituted or unsubstituted, hydrocarbon moiety; and X is a propoxy or greater alkoxy group.

44. The process according to claim 35 wherein the treating agent has the formula:
MₐD_{b}D′_{c}D″_{d}M′₂₋ₐ
wherein a is 0-2; b is 0-1000; c is 0-50; d is 0-50, provided that a+c+d is at least 1;
M is R¹₃₋ₑXₑSiO_{1/2} wherein R¹ is independently H, or a monovalent hydrocarbon group, X is hydroxyl group, and e is 0 or 1;
M′ is R²₃SiO_{1/2} wherein R² is independently H, a monovalent hydrocarbon group, or (CH₂)_{f}—(C6H₄)_{g}O—(C₂H₄O)ₕ—(C₃H₆O)ᵢ—(CₖH₂ₖO)ⱼ—R³, provided that at least one R² is (CH₂)_{f}—(C6H₄)_{g} O—(C₂H₄O)ₕ—(C₃H₆O)ᵢ—(CₖH₂ₖO)ⱼ—R³, wherein R³ is independently H, a monovalent hydrocarbon group or an alkoxy group, f is 1-10, g is 0 or 1, h is 1-50, i is 0-50, j is 0-50, k is 4-8;
D is R⁴₂SiO_{2/2} wherein R⁴ is independently H or a monovalent hydrocarbon group;
D′ is R⁵₂SiO_{2/2} wherein R⁵ is independently R² provided that at least one R⁵ is (CH₂)_{f}—(C6H₄)_{g} O—(C₂H₄O)ₕ—(C₃H₆O)ᵢ—(CₖH₂ₖO)ⱼ—R³, wherein R³ is independently H, a monovalent hydrocarbon group or an alkoxy group, f is 1-10, g is 0 or 1, h is 1-50, i is 0-50, j is 0-50, k is 4-8; and
D″ is R⁶₂SiO_{2/2} wherein R⁶ is independently H, a monovalent hydrocarbon group or (CH₂)ₗ(C₆H₄)ₘ(A)ₙ-[(L)ₒ-(A′)ₚ-]_{q}-(L′)ᵣZ(G)ₛ, wherein 1 is 1-10; m is 0 or 1; n is 0-5; o is 0-3; p is 0 or 1; q is 0-10; r is 0-3; s is 0-3; C₆H₄ is unsubstituted or substituted with a C₁₋₁₀ alkyl or alkenyl; A and A′ are each independently a linking moiety representing an ester, a keto, an ether, a thio, an amido, an amino, a C₁₋₄ fluoroalkyl, a C₁₋₄ fluoroalkenyl, a branched or straight chained polyalkylene oxide, a phosphate, a sulfonyl, a sulfate, an ammonium, and mixtures thereof; L and L′ are each independently a C₁₋₃₀ straight chained or branched alkyl or alkenyl or an aryl which is unsubstituted or substituted; Z is a hydrogen, carboxylic acid, a hydroxy, a phosphato, a phosphate ester, a sulfonyl, a sulfonate, a sulfate, a branched or straight-chained polyalkylene oxide, a nitryl, a glyceryl, an aryl unsubstituted or substituted with a C₁₋₃ alkyl or alkenyl, a carbohydrate unsubstituted or substituted with a C₁₋₁₀ alkyl or alkenyl or an ammonium; G is an anion or cation such as H⁺, Na⁺, Li⁺, K⁺, NH₄⁺, Ca⁺², Mg⁺², Cl⁻, Br⁻, I⁻, mesylate or tosylate.

45. The process according to claim 35 wherein the treating composition further comprises a leather adjunct selected from the group consisting of: perfumes, waterproofing agents, dye transfer inhibiting agents, dye fixating agents, conditioning agents, tanning agents and mixtures thereof.

46. A process according to claim 35 wherein the water is added separately from the leather article treating composition.

47. The process according to claim 35 wherein the water is added into the leather article treating composition prior to contacting the leather article to be treated.

48. A process for treating a leather article comprising contacting the leather article with a lipophilic fluid such that the leather article is treated.

49. A consumable leather article treating composition comprising:
a. from about 1% to about 100% of a treating agent;
b. from about 0% to about 99% of water;
c. from about 0% to about 99% of a lipophilic fluid;
d. optionally, from about 0% to about 99% of a leather adjunct.
